(19) United States
(12) Patent Application Publication
(10) Pub. No.: US 2003/0059493 A1
(43) Pub. Date: Mar. 27, 2003

(54) Clamping assembly for injection molding machine

(76) Inventors: Akira Yoshinaga, Shizuoka-ken (JP); Jun Koike, Shizuoka-ken (JP); Tatsuhiko Maru, Shizuoka-ken (JP); Fumiyuki Kato, Shizuoka-ken (JP); Makoto Nishizawa, Shizuoka-ken (JP)

Correspondence Address: PILLSBURY WINTHROP LLP, 1600 TYSONS BOULEVARD, MCLEAN, VA, 22102, US

(21) Appl. No.: 10/097,605

(22) Filed: Mar. 15, 2002

(30) Foreign Application Priority Data
Sep. 26, 2001 (JP) 2001-293278

(51) Int. Cl. B29C 45/64

(52) U.S. Cl. 425/589; 425/450.1

(57) ABSTRACT

A direct type clamping assembly for a motorized injection molding machine to maintain a clamping force for a predetermined time without causing motor stalling is disclosed. A stationary platen and back plate are fixedly attached to a base, and a movable platen is slidingly associated with the base. A housing is disposed in front of the back plate with coil springs disposed between the housing and the back plate. A nut of a ball-screw assembly is rotatably accommodated in the housing with a bearing. When the ball-screw assembly is rotatably driven, the movable platen moves forward, stopping when a mold is completely joined together. The housing can accordingly move backward as the ball-screw assembly is further rotatably driven, compressing the coil springs and generating and maintaining the clamping force. Slight rotation of the motor prevents motor stalling, and the resulting slight movement of the housing scarcely influences the clamping force.

### CROSS-REFERENCE TO RELATED APPLICATIONS

This application is based on and claims the benefit of priority from the prior Japanese Patent application No. 2001-293278, filed Sep. 26, 2001, the entire contents of which are incorporated herein by reference.

### BACKGROUND OF THE INVENTION

1. Field of the Invention

This invention relates to a direct type clamping assembly for a motorized injection molding machine, and more particularly, to a direct type clamping assembly for a motorized injection molding machine which enables a clamping force to be maintained for a predetermined time.

2. Description of the Related Art

Referring to FIG. 6, a conventional direct type clamping assembly for a motorized injection machine of the related art has a base 1, a stationary platen 3 and a back plate 62 on the base 1. A movable platen 4 is disposed in front of the back plate 62. A mold includes a stationary half mold 5 fastened to the stationary platen 3 and a movable half mold 6 fastened to the movable platen 4. The stationary platen 3 and the back plate 62 are joined by four tie rods 67 disposed through four through-holes located at the four corners of the movable platen 4. The movable platen 4 is supported on the tie rods 67 for forward and backward sliding movement on the base 1. One end of a screw 71 of a ball-screw assembly 70 is joined to load cell 75 disposed in back of the movable platen 4. A nut 72 of the ball-screw assembly 70 is supported with a bearing 77 in the back plate 62 so as to rotate. Motor 80 is in the base 1. A pulley 81 is fixed to an end of a shaft of the motor 80. A pulley 82 is fixed to one end of the nut 72. A timing belt 83 connects the pulley 81 and the pulley 82. The motor 80 drives the nut 72, therefore the movable platen 4 slides forward and backward.

As described above, in a conventional direct type clamping assembly for a motorized injection machine, a small extension of the tie rods 67 occurs during generation of a clamping force. As each of the tie rods 67 has a broad cross-sectional area and a high elastic constant, the extension of the tie rods 67 is small during clamping. Therefore, immediately after the stationary half mold 5 and the movable half mold 6 are completely joined together, the clamping force rapidly increases. Furthermore, resolution of the clamping force cannot be sufficiently high. Also, in the injection molding process, the clamping force has to be maintained during a cooling period, in which the motor 80 produces a constant torque without rotating for maintaining the clamping force. But, in producing torque without rotating, so called “stall” causes direct current in the motor 80 that leads to the motor 80 having a heat problem, which can damage the motor 80. In the case of molding a thick product, the clamping force should be maintained for a predetermined time sufficient to allow molding and/or cooling of the thick product, increasing the likelihood of motor 80 damage. Therefore, a conventional direct type clamping assembly for a motorized injection machine is disadvantageous for at least the above-described limitations.

### BRIEF SUMMARY OF THE INVENTION

This invention has been accomplished in view of overcoming the problems referred to above. Therefore, it is the object of the invention to provide a direct type clamping assembly for a motorized injection machine so that a clamping force can be maintained for a predetermined time when molding a thick product.

Namely, this invention provides a direct type clamping assembly for a motorized injection molding machine, including a motor, a rotation motion-rectilinear motion conversion device that converts rotation motion produced by the motor to rectilinear motion, a movable platen driven by the rotation motion-rectilinear motion conversion device, and an elastic member that provides the movable platen with a clamping force when clamping, wherein the motor rotates both clockwise and counter clockwise slightly to maintain the clamping force.

Also, this invention provides a direct type clamping assembly for a motorized injection molding machine, including a base, a back plate attached onto one end of the base, a stationary platen with a stationary half mold attached unto another end of the base, a movable platen with a movable half mold slidingly associated with the base so as to be slideable towards and away from the stationary platen, a ball-screw assembly of which one end is attached to the movable platen, a housing wherein a nut of the ball-screw assembly is disposed, at least one elastic member disposed between the back plate and the housing so as to be flexible in the direction in which the movable platen slides, and a motor disposed to rotate the nut of the ball-screw assembly, wherein the motor rotates both clockwise and counter clockwise slightly to maintain a clamping force generated by the elastic member.

Furthermore, this invention provides a direct type clamping assembly for a motorized injection molding machine, including a stationary platen with a stationary half mold, a movable platen with a movable half mold facing the stationary platen, a back-up plate disposed in back of the movable platen, at least one elastic member disposed between the movable platen and the back-up plate so as to be flexible in the direction which the movable platen slides, a plurality of ball-screw assemblies of which one end of each is disposed in the stationary platen, wherein a nut of each of the plurality of ball-screw assemblies is disposed adjacent to the back-up plate, and a motor disposed to rotate the screws of the ball-screw assemblies synchronously, wherein the motor rotates both clockwise and counter clockwise slightly to maintain a clamping force generated by the elastic member.

Preferably, the elastic member referred to above is a coil spring.

A movable platen of the present invention is driven forward and backward by a rotation motion-rectilinear motion conversion device, which converts rotation motion produced by the motor to rectilinear motion. There are various structures used to construct this invention. For example, two types of construction of this invention are disclosed below.

In a first case, a movable platen moves forward when a member of a rotation motion-rectilinear motion conversion device that moves rectilinearly, which is attached to the movable platen, is driven forward. Finally the movable platen stops when a stationary half mold and a movable half mold are completely joined together so that the movable platen is not able to move forward further. Since an elastic member is disposed between the back plate and a housing in which a rotational member of the rotation motion-rectilinear motion conversion device is disposed, the housing moves backward accordingly as the rotation motion-rectilinear motion conversion device continues to be driven. Namely, by means of giving a deformation, in this case compression deformation, a reaction force of the elastic member is generated and applied to the mold as a clamping force.

Therefore, by designing a spring constant of the elastic member properly, the clamping force is generated by deformation of the elastic member. The deformation of the elastic member is much larger than the deformation of the tie rods of the conventional direct type clamping assembly. Namely, slight movement of the housing caused by driving the rotation motion rectilinear motion conversion device by a motor scarcely influences the clamping force. To prevent the motor from stalling, the motor needs only to rotate. According to this invention, the elastic member generates the clamping force so that the clamping force is maintained for a predetermined time by slight rotation of the motor without the motor stalling. Therefore this invention enables the aforementioned clamping assembly to be preferable for molding a thick product, and extending the life of the motor.

In a second case, the movable platen moves forward with a back-up plate when a member of a rotation motion-rectilinear motion conversion device that moves rectilinearly, which is attached to the back-up plate disposed in back of the movable platen, is driven forward. Finally the movable platen stops when a stationary half mold and a movable half mold are joined together so that the movable platen is not able to move forward further. Since an elastic member is disposed between the back-up plate and the movable platen, the back-up plate still moves forward accordingly as the rotation motion-rectilinear motion conversion device continues to be driven. Namely, by means of giving a deformation, in this case compression deformation, a reaction force of the elastic member is generated and applied to the mold as a clamping force.

Therefore, by designing a spring constant of the elastic member properly, the clamping force is generated by deformation of the elastic member. The deformation of the elastic member is much larger than the deformation of the tie rods of the conventional direct type clamping assembly. Namely, slight movement of the back-up plate caused by driving the rotation motion rectilinear motion conversion device by a motor scarcely influences the clamping force. To prevent the motor from stalling, the motor needs only to rotate. According to this invention, the elastic member generates the clamping force so that the clamping force is maintained for a predetermined time by slight rotation of the motor without the motor stalling. Therefore this invention enables the aforementioned clamping assembly to be preferable for molding a thick product, and getting extended life of the motor.

### BRIEF DESCRIPTION OF THE DRAWINGS

FIG. 1 is a schematic side elevation view of a clamping assembly according to a first embodiment of the present invention;

FIG. 2 is a schematic side elevation view of a clamping assembly according to a second embodiment of the present invention;

FIG. 3 is a cross-sectional view showing the clamping assembly of FIG. 2 taken along the line D-D of FIG. 4;

FIG. 4 is an end view showing the clamping assembly of FIG. 2 from the left end;

FIG. 5 is a cross-sectional view showing the clamping assembly of FIG. 2 taken along the line E-E of FIG. 4; and

FIG. 6 is a side elevation view of a conventional direct type clamping assembly for an injection molding machine in the related art.

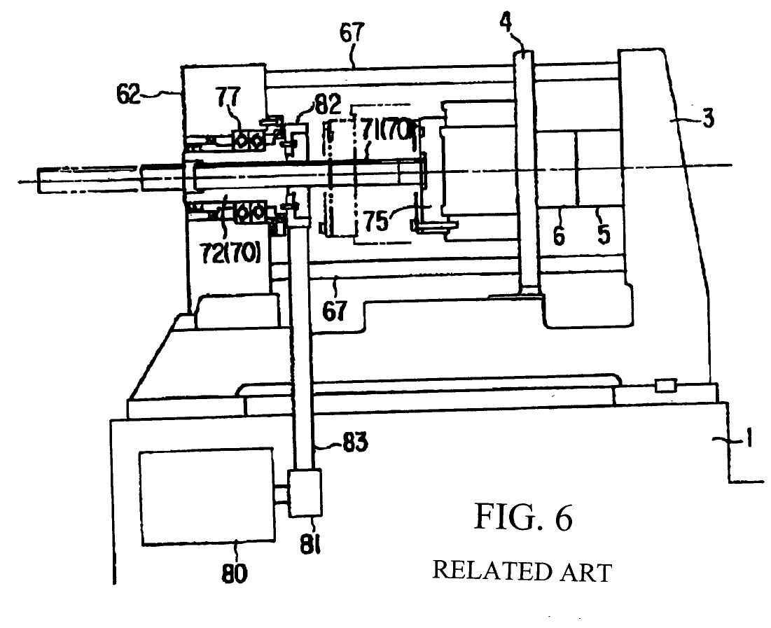

### DESCRIPTION OF THE PREFFERED EMBODIMENTS

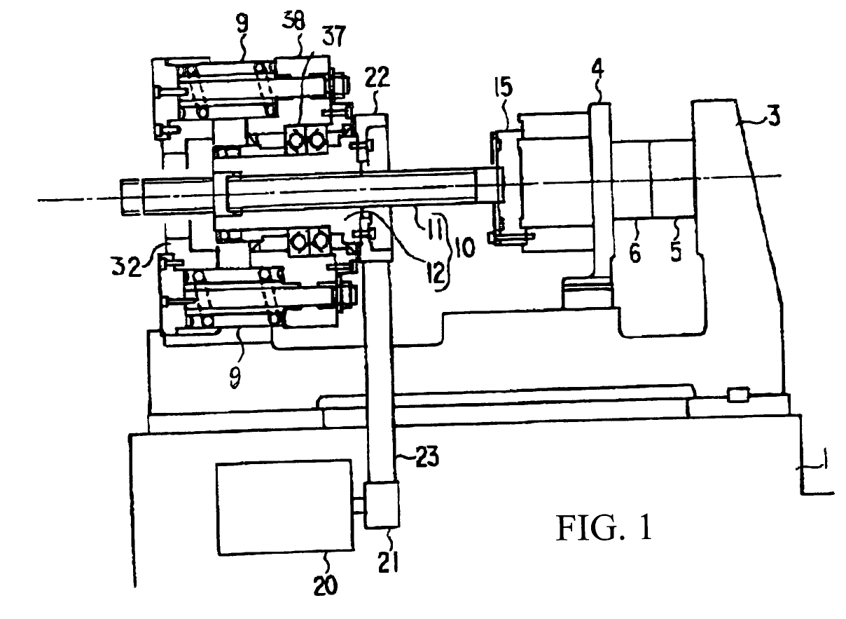

FIG. 1 shows schematically a first embodiment of a direct type clamping assembly. In FIG. 1, the reference number 1 represents a base, 32 a back plate, 3 a stationary platen, 4 a movable platen, 5 a stationary half mold, 6 a movable half mold, 38 a housing, 9 a coil spring elastic member, 10 a ball-screw assembly, 11 a screw of the ball-screw assembly 10, and 12 a nut of the ball-screw assembly 10.

The stationary platen 3 and the back plate 32 are disposed on the base 1. The movable platen 4 is disposed in front of the back plate 32. A mold includes the stationary half mold 5 fastened to the stationary platen 3 and the movable half mold 6 fastened to the movable platen 4. The movable platen 4 moves forward and backward slidingly with respect to the base 1.

The housing 38 is disposed in front of the back plate 32. The nut 12 is accommodated in the housing 38. Coil springs 9 are disposed between the back plate 32 and the housing 38. One of the coil springs 9 is disposed upward of the ball-screw assembly 10, and another downward of the ball-screw assembly 10. The coil springs 9 extend and compress in parallel with an axis of the screw 11. A load cell 15 is disposed in back of the movable platen 4. As shown in FIG. 1 as the right end of the screw 11, a front end of the screw 11 is attached to the movable platen 4.

A motor 20 is disposed in the base 1. As shown in FIG. 1 as fixed to the right end of the nut 12, a pulley 22 is fixed to a front end of the nut 12. A pulley 21 is fixed to an end of a shaft of the motor 20. A timing belt 23 connects the pulley 21 and the pulley 22. The motor 20 drives the nut 12 such that the movable platen 4 slides forward and backward with respect to the base 1.

As mentioned above, in a first embodiment of this invention, the ball-screw assembly 10, which drives the movable platen 4, is disposed in front of the back plate 32 with the coil springs 9. When the ball-screw assembly 10 is driven, the movable platen 4 moves forward. The movable platen 4 stops moving forward when the stationary half mold 5 and the movable half mold 6 are completely joined together such that the movable platen 4 is not able to move forward further. Since the coil springs 9 are disposed between the back plate 32 and the housing 38, the housing 38 is able to move backward accordingly as the nut 12 continues to be driven. Furthermore, since the back plate 32 is fixed onto the base 1, it does not move with respect to the base 1 such that the coil springs 9 compress accordingly as the housing 38 moves backward, generating a clamping force. Namely, by means of providing a compression deformation, a reaction force of the coil springs 9 is generated and applied to the mold as the clamping force. When the clamping force detected by the load cell 15 reaches a preset value, the motor 20 rotates clockwise and counterclockwise slightly.

By designing a spring constant of the coil springs 9 properly, the deformation of the coil springs 9, which generates the clamping force, is much larger than the deformation of the tie rods 67 of the conventional direct type clamping assembly. Namely, slight movement of the housing 38 caused by driving the ball-screw assembly 10 by the motor 20 scarcely influences the clamping force. To prevent the motor 20 from stalling, the motor 20 needs only to rotate slightly. According to this invention, the coil springs 9 generate the clamping force, and the clamping force is maintained for a predetermined time by slight rotation of the motor 20 without the motor 20 stalling. Therefore, this invention enables the aforementioned clamping assembly to be preferable for molding a thick product, and getting extended life of the motor 20.

It will be apparent to one ordinarily skilled in the art that a pair of the coil springs 9 may be disposed diagonally opposed to each other at the back plate 32, and also four coil springs 9 may be disposed at the four corners of the back plate 32.

Further, the first embodiment mentioned above has no tie rods, but it will be apparent to one ordinarily skilled in the art that the clamping assembly set forth above may comprise one or more tie rods.

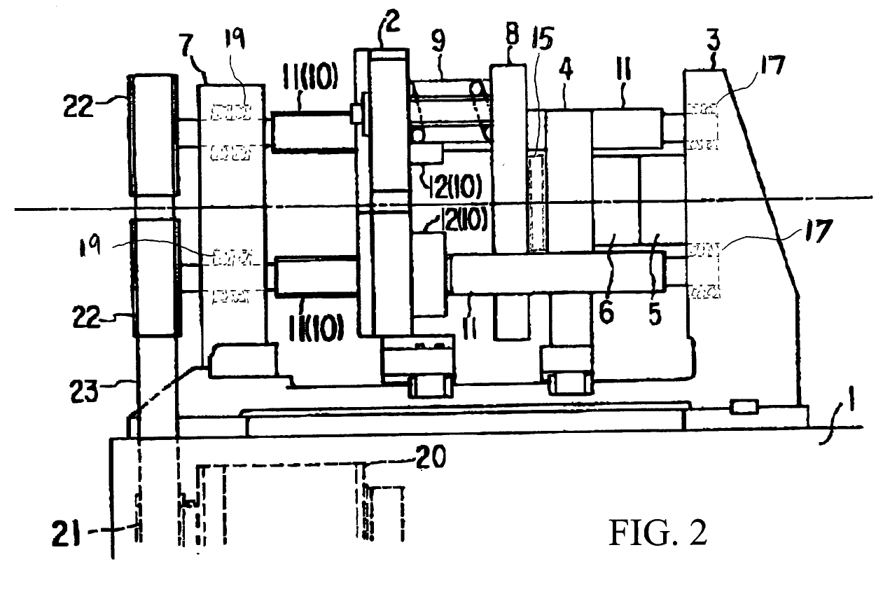

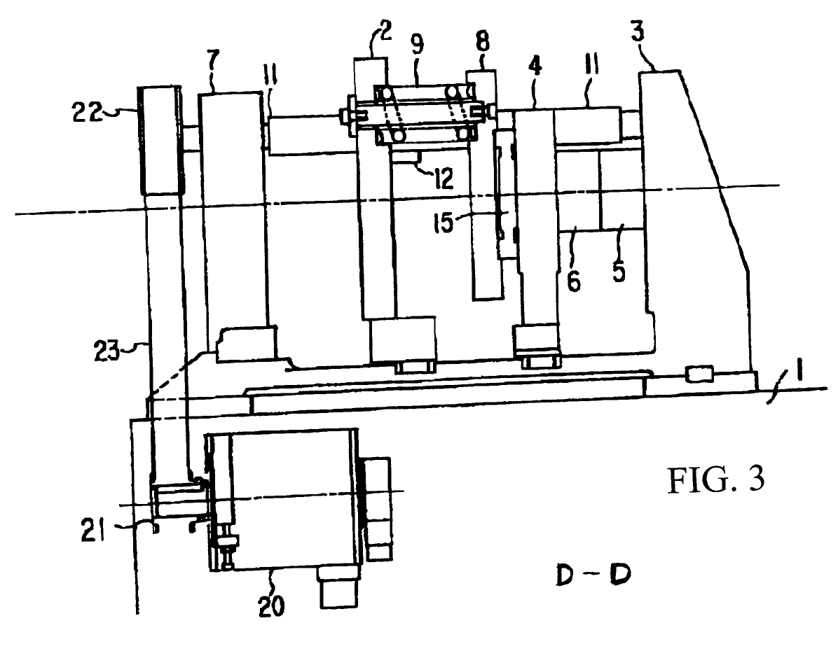

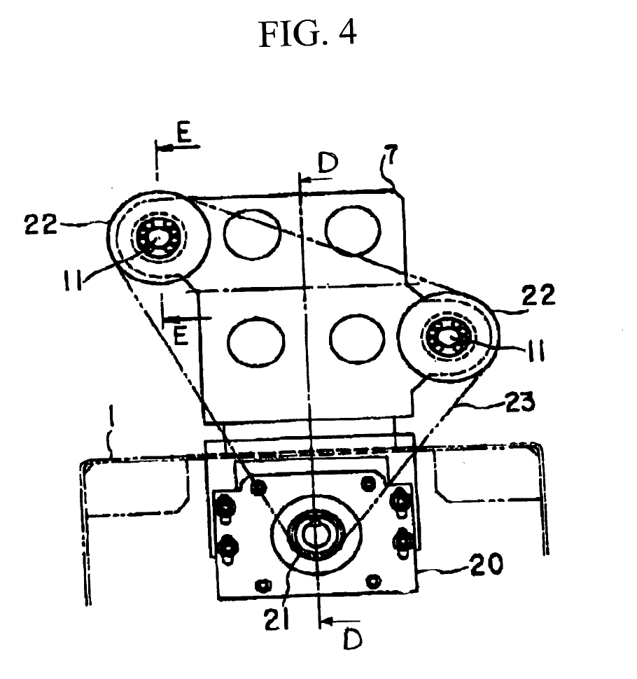

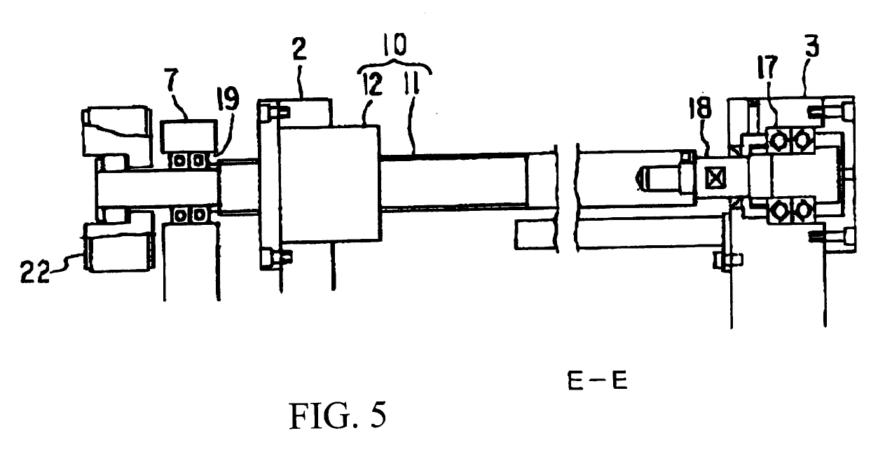

FIGS. 2-5 show schematically a second embodiment of a direct type clamping assembly. FIG. 2 is a schematic side elevation view showing the second embodiment, and FIG. 3 is a cross-sectional view showing the second embodiment of FIG. 2 taken along the line D-D of FIG. 4. FIG. 4 illustrates an end view of the second embodiment of FIG. 2 from a left end, and FIG. 5 is a cross-sectional view showing the second embodiment of FIG. 2 taken along the line E-E of FIG. 4.

In FIG. 2, the reference number 3 represents a stationary platen, 4 a movable platen, 5 a stationary half mold, 6 a movable half mold, 2 back-up plate, 9 a coil spring-elastic member, 10 a ball-screw assembly, 11 a screw of the ball-screw assembly 10, 12 a nut of the ball-screw assembly 10.

The stationary platen 3 and a support plate 7 are disposed on a base 1. The movable platen 4 is disposed facing the stationary platen 3. A mold includes the stationary half mold 5 fastened to the stationary platen 3 and the movable half mold 6 fastened to the movable platen 4. The movable platen 4 moves forward and backward slidingly with respect to the base 1.

The back-up plate 2 is disposed between the support plate 7 and the movable platen 4. The back-up plate 2 slides forward and backward with respect to the base 1. Nuts 12 are disposed diagonally opposed from each other at the back-up plate 2, as shown in FIG. 4. Screws 11 are disposed through through-holes formed in the back-up plate 2. Bearings 17, shown in more detail in FIG. 5, are accommodated in holes formed in the stationary platen 3. Bearings 19, shown in more detail in FIG. 5, are accommodated in holes formed in the support plate 7. As shown in FIG. 2 on the right ends of the screws 11, front ends of the screws 11 are attached to the stationary platen 3 with the bearings 17, and rear ends, as shown in FIG. 2 on the left ends of the screws 11, extend through through-holes of the support plate 7 with the bearings 19 so as to enable the screws 11 to rotate.

A load cell 15 is disposed between a spring support 8 and the movable platen 4. Four coil springs 9 are disposed between the back-up plate 2 and the spring support 8.

A motor 20 is disposed in the base 1. A pulley 22 is fixed to a back end (a left end as shown in FIG. 2) of each screw 11. A pulley 21 is fixed to an end of a shaft of the motor 20. A timing belt 23 connects the pulley 21 and the pulleys 22.

The motor 20 drives each screw 11 so that the back-up plate 2 moves forward and backward. The movable platen 4 connected to the back-up plate 2 with the coil springs 9 slides forward and backward with respect to the base 1 according to movement of the back-up plate 2.

When each ball-screw assembly 10 is driven, the movable platen 4 moves forward. Since the coil springs 9 are disposed between the back-up plate 2 and the spring support 8, the spring support 8 moves forward accordingly as each ball-screw assembly 10 is driven. Finally the movable platen 4 stops when the movable half mold 6 touches the stationary half mold 5 such that the movable platen 4 is not able to move forward further. Since the movable platen 4 is not able to move forward, the coil springs 9 compress and generate a clamping force. Namely, by means of providing a compression deformation, a reaction force of the coil springs 9 is generated and applied to the mold as the clamping force. When the clamping force detected by the load cell 15 reaches a preset value, the motor 20 rotates clockwise and counterclockwise slightly.

By designing a spring constant of the coil springs 9 properly, the deformation of the coil springs 9, which generates the clamping force, is much larger than the deformation of the tie rods 67 of the conventional direct type clamping assembly. Namely, slight movement of the back-up plate 2 caused by driving the ball-screw assembly 10 by the motor 20 scarcely influences the clamping force. To prevent the motor 20 from stalling, the motor 20 needs only to rotate slightly. According to this invention, the coil springs 9 generate the clamping force, and the clamping force is maintained for a predetermined time by slight rotation of the motor 20 without the motor 20 stalling. Therefore, this invention enables the aforementioned clamping assembly to be preferable for molding a thick product, and getting extended life of the motor 20.

Incidentally, screws 11 of this embodiment of the invention function as the tie rods 67 of a conventional clamping assembly so that this invention is able to reduce the number of parts used in a clamping assembly and enables a structure of it to be simplified.

Using a plurality of ball-screw assemblies 10 in this invention enables the clamping force to be shared between each ball-screw assembly 10. Therefore, the size of each ball-screw assembly 10 may be reduced.

Further, a clamping assembly, like the second embodiment mentioned above, has only two ball-screw assemblies 10, so that space used to accommodate the mold becomes wider than the space in a conventional clamping assembly having four tie rods.

It will be appreciated that the above descriptions are intended to only to serve as examples, and that many other embodiment are possible within the scope of the present invention.

What is claimed is:

1. A direct type clamping assembly for a motorized injection molding machine, comprising:
a motor;
a rotation motion-rectilinear motion conversion device that converts rotation motion produced by the motor to rectilinear motion;
a movable platen driven by the rotation motion-rectilinear motion conversion device; and
an elastic member that provides the movable platen with a clamping force when clamping, wherein the motor rotates both clockwise and counter clockwise slightly to maintain the clamping force.

2. A direct type clamping assembly for a motorized injection molding machine, comprising:
a base;
a back plate attached onto one end of the base;
a stationary platen with a stationary half mold attached onto another end of the base;
a movable platen with a movable half mold slidingly associated with the base so as to be slidable towards and away from the stationary platen;
a ball-screw assembly of which one end is attached to the movable platen;
a housing wherein a nut of the ball-screw assembly is disposed;
at least one elastic member disposed between the back plate and the housing so as to be flexible in the direction which the movable platen slides; and
a motor disposed to rotate the nut of the ball-screw assembly, wherein the motor rotates both clockwise and counter clockwise slightly to maintain a clamping force generated by the elastic member.

3. A direct type clamping assembly for a motorized injection molding machine, comprising:
a stationary platen with a stationary half mold;
a movable platen with a movable half mold facing the stationary platen;
a back-up plate disposed in back of the movable platen;
at least one elastic member disposed between the movable platen and the back-up plate so us to be flexible in the direction which the movable platen slides;
a plurality of ball-screw assemblies of which one end of each of the plurality of ball-screw assemblies is disposed in the stationary platen, wherein a nut of each of the plurality of ball-screw assemblies is disposed adjacent to the back-up plate; and
a motor disposed to rotate the screws of the ball-screw assemblies synchronously, wherein the motor rotates both clockwise and counter clockwise slightly to maintain a clamping force generated by the elastic member.

4. The clamping assembly of claims 1 through 3, wherein the elastic member comprises a coil spring.

5. An injection molding machine having the direct type clamping assembly claimed in claims 1 through 3.

6. An injection molding machine having the direct type clamping assembly claimed in claim 4.
